(19) United States
(12) Patent Application Publication
(10) Pub. No.: US 2014/0000980 A1
(43) Pub. Date: Jan. 2, 2014

(54) Sound Attenuating Composite Articles And Methods Of Making Same

(71) Applicant: International Automotive Components Group North America, Inc., Southfield, MI (US)

(72) Inventors: Timothy Michael CARSON, Plymouth, MI (US); Timothy Joel ALLISON, Marion, NC (US); Ephraim Jack HOBBS, Asheville, NC (US); Robert Bradley CARAWAY, Gaffney, SC (US)

(21) Appl. No.: 13/922,032

(22) Filed: Jun. 19, 2013

Related U.S. Application Data
(60) Provisional application No. 61/662,159, filed on Jun. 20, 2012.

(51) Int. Cl. G10K 11/00; B05D 5/00

(52) U.S. Cl. CPC G10K 11/002; B05D 5/00
USPC 181/290; 427/256

(57) ABSTRACT

A sound attenuating composite article comprising an acoustic decoupler layer comprising a fiber substrate; a acoustic barrier layer comprising a filled polymeric material; and wherein the filled polymeric material is formed in place on and bonded to the fiber substrate at one or more localized areas on the fiber substrate. A method of forming a sound attenuating composite article comprising providing a fiber substrate, wherein the fiber substrate provides a acoustic decoupler layer; providing a filled polymeric material, wherein the filled polymeric material provides an acoustic barrier layer; and forming the filled polymeric material in place on the fiber substrate at one or more localized areas on the fiber substrate and bonding the filled polymeric material to the fiber substrate at the one or more localized areas.

### CROSS REFERENCE TO RELATED APPLICATIONS

The present application claims the benefit of the filing date of U.S. provisional application Ser. No. 61/662,159, filed Jun. 20, 2012, the teachings of which are incorporated herein by reference.

### FIELD

The present invention relates generally to sound attenuation and more particularly to methods and apparatus for producing sound attenuating articles for motor vehicles. The sound attenuation achieved herein may be provided by a polymeric layer applied to a fiber layer. The polymeric layer may be sourced from a spray polymeric composition, containing inorganic filler, such as a spray polyurethane formulation.

### BACKGROUND

It is generally considered desirable to reduce the level of noise within passenger compartments of vehicles. External noises, such as road noise, engine noise, vibrations, etc., as well as noises emanating from within passenger compartments, may be attenuated through the use of various acoustical materials. Sound attenuating materials for vehicles, such as automobiles, are conventionally used in the dashboard, in conjunction with carpeting for floor panels, in the wheel wells, in the trunk compartment, under the hood, as part of the headliner, A-pillars, etc.

A variety of methods appear in the art for the purpose of addressing sound attenuation in vehicles. For example, in U.S. Pat. No. 7,063,183 there is reference to the use of a sound attenuating laminate that has a fiber layer and a mass layer in opposing relationship. As shown in FIG. 1 of the '183 Patent, the fiber layer and mass layer are part of a laminate 10 wherein the mass layer is coextensive with the fiber layer over the whole laminate 10. Furthermore, as shown, the mass layer has a uniform thickness. However, sound attenuation in a motor vehicle may vary substantially from one location to another. Thus, in certain locations, it may not be necessary to use the mass layer where noise levels are low, while in other locations it may be desirable to locally increase the thickness of the mass layer where noise levels may be greater. Thus, laminate 10 may be understood to suffer from applying a mass layer in locations where a mass layer is not necessarily required in areas of a motor vehicle having low noise levels, which adds unnecessary cost and weight, as well as not being able to provide a thick enough mass layer in other locations where noise levels are high and greater sound attenuation is required.

U.S. Pat. No. 6,631,785 makes reference to sound attenuating composite articles that includes a damping layer, decoupler layer, scrim/web layer and a porous upholstery material sandwiched together. However, the '785 Patent may be understood to suffer from the same inadequacies as the '183 Patent.

### SUMMARY

The present disclosure provides sound attenuating composite articles and methods of their manufacture, wherein the sound attenuating composite articles may particularly comprise an acoustic barrier layer and an acoustic absorber/decoupler layer.

The acoustic barrier layer may be particularly formed from a polymeric material spray applied to the absorber/decoupler layer, which may particularly comprise a fiber substrate. The sprayed polymeric material may be applied to one or more localized areas of the sound attenuating composite article requiring use of a barrier layer for greater sound attenuation. Furthermore, the thickness of the spray applied polymeric layer may be varied at each applied area, as well as within a particular area, to vary the localized acoustical properties of the barrier layer according to a sound profile of the motor vehicle.

In addition to providing the foregoing sound attenuation benefits, the polymeric barrier layer is spray formed in place on the fiber substrate without use of a forming surface other than the surface of the fiber substrate, which reduces tooling costs and enables quick changes in spray pattern from one part to the next part. Moreover, the sprayed polymeric barrier layer may be formed in place from reactive components which react to form a thermoset polymer. As such, the barrier layer may be bonded directly to the surface of the fiber substrate without need for added or separate adhesive layers.

In certain embodiments, a sound attenuating composite article may be provided which comprises an acoustic absorber and/or acoustic decoupler layer comprising a fiber substrate; a acoustic barrier layer comprising a filled polymeric material; and wherein the filled polymeric material is formed in place on and bonded to the fiber substrate at one or more localized areas on the fiber substrate.

In certain embodiments, a method of forming a sound attenuating composite article may be provided, wherein the method comprises providing a fiber substrate, wherein the fiber substrate provides a acoustic decoupler layer; providing a filled polymeric material, wherein the filled polymeric material provides an acoustic barrier layer; and forming the filled polymeric material in place on the fiber substrate at one or more localized areas on the fiber substrate and bonding the filled polymeric material to the fiber substrate at the one or more localized areas.

In certain embodiments, the method may comprise spraying and reacting the filled polymeric material in place on the fiber substrate such that the filled polymeric material cures on the fiber substrate and bonds the filled polymeric material to the fiber substrate at the one or more localized areas.

In certain embodiments, the method may comprise forming the filled polymeric material in place on the fiber substrate in at least one localized area of the fiber substrate with a thickness which varies from a minimum thickness to a maximum thickness of the localized area; and varying the thickness of the localized area such that the maximum thickness of the localized area is in a range between 10-700% greater than the minimum thickness of the localized area.

In certain embodiments, the method may comprise forming the filled polymeric material in place on the fiber substrate in at least first and second localized areas which each have a thickness; wherein the thickness of the first localized area is greater than the thickness of the second localized area; and wherein the thickness of the first localized area is in a range between 10-700% greater than the thickness of the second localized area.

In certain embodiments, the method may comprise forming the fiber substrate into a shaped article before forming the filled polymeric material in place on the fiber substrate at one or more localized areas on the fiber substrate and bonding the filled polymeric material to the fiber substrate at the one or more localized areas.

In certain embodiments, the method may comprise forming the fiber substrate into a shaped article after forming the filled polymeric material in place on the fiber substrate at one or more localized areas on the fiber substrate and bonding the filled polymeric material to the fiber substrate at the one or more localized areas.

### FIGURES

The above-mentioned and other features of this disclosure, and the manner of attaining them, will become more apparent and better understood by reference to the following description of embodiments described herein taken in conjunction with the accompanying drawings, wherein:

FIG. 1 is a side view of a fiber substrate according to the present disclosure being heated between two opposing heaters;

FIG. 2 is a side view of the fiber substrate of FIG. 1 being introduced into a mold to be molded into a three dimensional article;

FIG. 3 is a side view of the molded fiber substrate of FIG. 1 having the barrier layer applied thereto;

FIG. 4A is a side view of the molded fiber substrate of FIG. 1 with the barrier layer applied to the entire surface of the fiber substrate with a uniform thickness;

FIG. 4B is a side view of the molded fiber substrate of FIG. 1 with the barrier layer applied to the entire surface of the fiber substrate with a varying thickness;

FIG. 4C is a side view of the molded fiber substrate of FIG. 1 with the barrier layer applied to a plurality of localized areas of the surface of the fiber substrate with a uniform thickness;

FIG. 4D is a side view of the molded fiber substrate of FIG. 1 with the barrier layer applied to plurality of localized areas of the surface of the fiber substrate such that a thickness of one or more of the localized areas is greater than a thickness of one or more of the other localized areas;

FIG. 4E is a side view of the molded fiber substrate of FIG. 1 with the barrier layer applied to plurality of localized areas of the surface of the fiber substrate such that the thickness of one or more of the localized areas varies within the localized area, particularly with a maximum thickness of the barrier layer being within the confines of the localized area (i.e. not at the perimeter thereof); and

FIG. 4F is a side view of the molded fiber substrate of FIG. 1 with the barrier layer applied to plurality of localized areas of the surface of the fiber substrate such that a maximum thickness of a localized area may be located at a first location of the perimeter of the localized area, and the minimum thickness of the localized area may be located at a second location of the perimeter of the localized area.

FIG. 4G is a plan view of the molded fiber substrate of FIG. 1 with the barrier layer applied to plurality of localized areas of the surface of the fiber substrate with the barrier layer is various shapes of circular, oval and rectangular geometry.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

The present disclosure relates to systems, methods and apparatus for producing sound attenuating (reducing) articles, such as multi-layered sound attenuating articles in which at least one layer provides an acoustic barrier, which may also be referred to as a mass, and another layer provides an acoustic absorber/decoupler, which may also be referred to as a spring. An acoustic barrier may be understood to block transmission of sound, while an acoustic absorber works by damping sound waves. A decoupler may be understood to separate or decouple the acoustic barrier from the vehicle body (e.g. sheet metal) to enhance the sound reduction of the acoustic barrier.

More particularly, the present disclosure relates to sound attenuating articles for motor vehicles, which may be used in applications such as dash inner insulators (i.e. inside vehicle cabin between the firewall and the instrument panel), vehicle flooring insulators such as carpet backing, and inner wheel well insulators such as wheel well liners. Still, the sound attenuating articles of the present disclosure may be used in other vehicle applications including trunk insulators, under hood insulators, engine and/or transmission insulators, close-out panel insulators, overhead (headliner) insulators, door and body panel insulators and pillar insulators.

In a mass-spring system, the mass element may be understood to be formed of a layer of relatively high density material, and the spring element may be understood to be formed by a layer of relatively low density material. The phrase “mass-spring” may be used to define a system that provides sound attenuation through the combination of the mass and spring elements. A sound attenuation article may be said to work as a “mass-spring” if its physical behavior can be represented by the combination of a mass element and a spring element. A mass-spring system may be understood to act as a sound attenuator/insulator mainly due to the mechanical characteristics of its elements.

As provided herein, an article having at least two layers for sound attenuation is disclosed. In exemplary embodiments, a filled polymeric layer is applied to a fiber layer to form a two layer article in the form of acoustic barrier and absorber/decoupler. If additional acoustic properties are desired, the thickness of the filled polymeric layer may be increased and/or the absorber/decoupler may have multiple layers to achieve the desired acoustic attenuation results.

The filled polymeric barrier layer may particularly comprise a filled polyurethane polymer, which is spray applied directed onto the one or more fiber layer(s), which provides a substrate. The spraying may be performed solely at selected localized areas (i.e. regions or islands) on the fiber layer, or to the entire fiber layer, depending on the particular location that sound attenuation is desired, as well as the amount of sound attenuation that is to be realized.

The polyurethane polymer may particularly be formed of a polyurethane composition that may be mixed in a spray head (also referred to as a mixhead) before application to the fiber layer. The polyurethane may be particularly formulated to set-up (cure and solidify) relatively quickly, and as such may also be referred to as a thermoset polyurethane.

The polyurethane may be sourced from diisocyanates and diols and may particularly be based on poly-methylene diisocyanate (PMDI) as a component thereof. Accordingly, the spray polyurethane may comprise a two-component system wherein the isocyanate amounts to one stream and the extender compounds (e.g. diols and/or polyols) amount to the second stream which are mixed in the spray head. One particular spray polyurethane may be sourced from Huntsman having a polyol designated as Acoustiflex SK8409 and an isocyanate designated as Suprasec 2310.

The polyol and isocyante streams may be further mixed at the mixhead with a third steam in the form of one or more fillers, such as an inorganic mineral filler. Exemplary inorganic mineral fillers may include barium sulfate (BaSO₄), calcium carbonate (CaCO₃) and blends thereof as well as other inorganic salt fillers. The fillers may also include magnetite (Fe₃O₄).

Once suitably mixed, the filled polyurethane may be sprayed from the spray head as a highly-viscous liquid, and may particularly begin to set-up (cure) within about 10 to 15 seconds after it contacts the fiber layer. In about 2-4 minutes, the filled polyurethane barrier layer is cohesive and its surface is tack-free. The filled polyurethane spray may particularly have a viscosity at 70° C. in a range of 1,000-2,000 pascal-seconds as it emerges the spray gun.

Filler loading level in the spray polyurethane may generally be up to 80% by weight of the barrier composition. More particularly, filler levels are in the range of 30%-80% by weight, more particularly in the range of 50%-80% by weight, and even more particularly, in the range of 70%-80% by weight. Filler levels may be adjusted depending upon the sound attenuation to be achieved along with consideration of the effect of filler on the mechanical properties of the spray coating in its fully polymerized and cured state.

The spray equipment may particularly be a Krauss-Maffei tandem piston spray apparatus or a Cannon compact spray unit. Flow rates that may be achieved may particularly be in the range of 50-150 grams/second. The thickness of the sprayed polyurethane layer may particularly be in the range of 0.25-10 millimeters, and more particularly in the range of 4-10 millimeters. However, the thickness may be less or greater for a given application. The cured polyurethane coating may have an area density (weight/area) in the range of 100-8,000 grams/meter², and more particularly have an areal density in the range of 1,500-8,000 grams/meter². Furthermore, the cured polyurethane coating may have a volumetric density (weight/volume) in the range of 1.4-2.5 grams/cubic centimeter, and more particularly in the range of 2.3-2.5 grams/cubic centimeter.

The fiber substrate for coating with the above-reference polyurethane formulations may include a fiber bat that may be flat (i.e. planar as provided from the bat forming process) and/or molded to a desired three-dimensional shape. Accordingly, the fibrous batting may particularly be thermoformable (i.e. the fiber substrate may be shaped with the application of heat and subsequently cooled to retain the shape), particularly by the use of thermoplastic fibers.

The fibers may include fibers from natural and synthetic origin. In addition to thermopolastic fibers, the fiber substrate may also include thermoset fiber materials such as epoxy and/or phenolic based compositions. Batting fibers may therefore particularly include polyester or copolyester batting as well as needled polyester configurations. The fibers may be chopped or continuous. The fiber substrate may be provided from roll-stock, or be formed into a planar sheet from fiber bails which are opened, carded and cross-lapped.

The fiber substrate may particularly have a thickness as low as 0.25 millimeters. With regards to maximum thickness, the thickness of the fiber substrate may be as high as necessary as dictated by the requirements for sound attenuation at issue. In certain embodiments, the fiber substrate may have a thickness of 0.25-75 millimeters, however higher thicknesses may be readily achieved. More particularly, the fiber substrate may have a thickness in a range of 4-30 millimeters, and even more particularly in a range of 6-25 millimeters.

The fiber substrate, which serves herein as an absorber and decoupling layer, may particularly have fiber area density in a range from 30-6,000 grams/meter², and more particularly have an area density in a range from 500-3,500 grams/meter². The fiber substrate may be formed by thermobonding or by blowing of fibers into a 2-dimensional screen mold or into a 3-dimensional screen mold. The fiber substrate may also comprise needled fiber, spunbond fibers, spunlace fibers, or rely upon any other technique that may afford physically bonded fibers for substrate formation.

Needled fibers, particularly in the form of needle punched nonwovens are created by mechanically orienting and interlocking the fibers of a spunbonded or carded web. This mechanical interlocking is achieved with thousands of barbed felting needles repeatedly passing into and out of the web.

Spunbond non-woven fabrics may be produced by depositing extruded, spun filaments onto a collecting belt in a uniform random manner followed by bonding the non-woven fibers. The fibers may be separated during the web laying process by air jets or electrostatic charges. The collecting surface is usually perforated to prevent the air stream from deflecting and carrying the fibers in an uncontrolled manner. Bonding imparts strength and integrity to the web by applying heated rolls or hot needles to partially melt the polymer and fuse the fibers together.

Spunlaced fibers, on the other hand, involves entangling a web of loose fibers on a porous belt or moving perforated or patterned screen to form a sheet structure by subjecting the fibers to multiple rows of fine high-pressure jets of water which may be referred to as hydroentanglement.

A thermally bonded non-woven fiber substrate may be formed wherein at least a percentage of the fibers are thermoplastic binder fibers, which may comprise bicomponent fibers. With bicomponent binder fibers, the binder fibers have an outer sheath which melts at a relatively low temperature, and the core which melts at a higher temperature. As such, nonwoven fabrics made with such binder fibers can be thermally bonded together simply by heating the fabric to melt the sheath but not the core of the binder fibers. Upon cooling, the molten sheath resolidifies, thus gluing the other fibers together and producing a thermally bonded fabric.

Alternatively, the fiber substrate may be formed from being melt blown, in which high-velocity air blows a molten thermoplastic resin from an extruder die tip onto a conveyor or takeup screen to form a fine fiberous and self-bonding web.

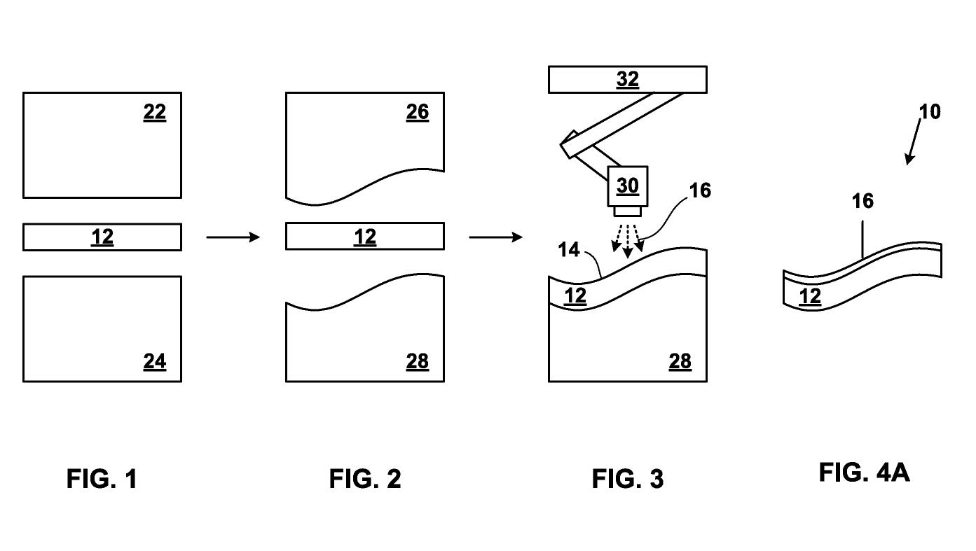

Referring now to FIGS. 1-4 there is shown a method to manufacture a sound attenuating composite article 10 according to the present disclosure. As shown in FIG. 1, the fiber substrate 12 is introduced between two heaters 22 and 24 to a temperature which softens bicomponent fibers mixed with staple fibers. As shown in FIG. 2, the heated fiber substrate 12 is then introduced between the mold halves 26, 28 of a compression mold to be thermoformed into a three dimensional article. As shown in FIG. 3, the molded/shaped fiber substrate 12 is moved to a third station wherein the filled polyurethane 16 is applied to surface 14 thereof from mixer 30 of a robot 32. The polyurethane 16 may flow into the interstices between the fibers, as well as bond to the fibers directly without flowing and bleeding through the fiber substrate 12.

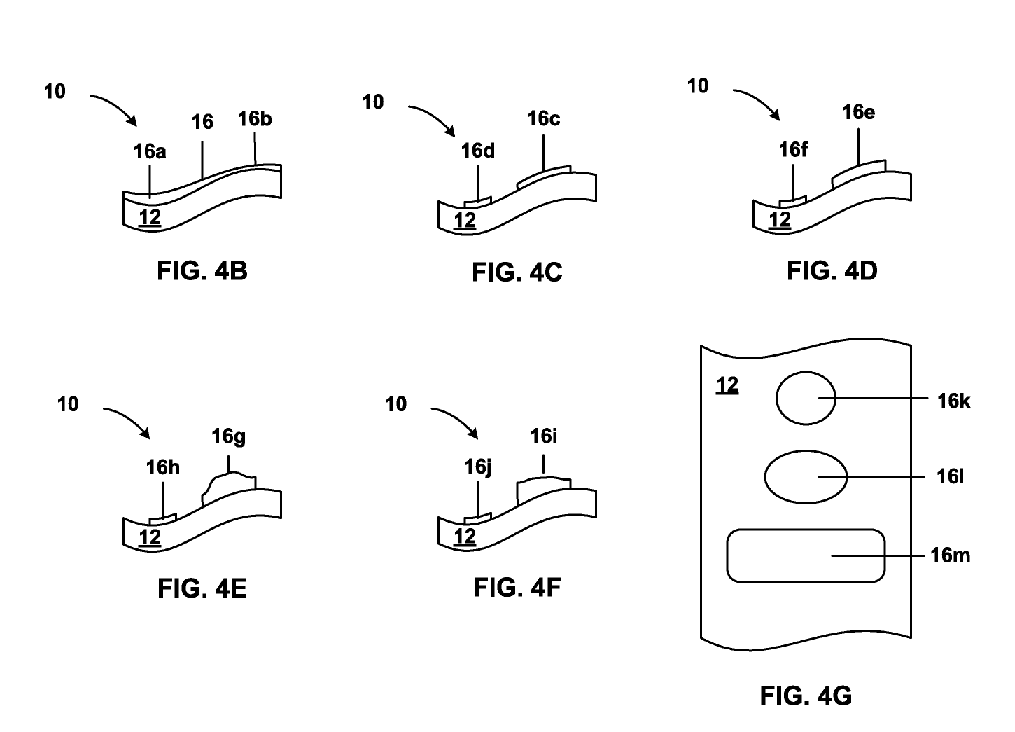

As shown in FIG. 4A, the polyurethane 16 may be coextensive with the fiber substrate 12 over the whole sound attenuating composite article 10, and may have a uniform thickness. However, in FIG. 4B, while the polyurethane 16 is coextensive with the fiber substrate 12 over the whole sound attenuating composite article 10, the maximum thickness at 16a may be 10% to 700% thicker than the minimum thickness at 16b, and more particularly 50% to 400% thicker than the minimum thickness at 16b.

As shown in FIG. 4C, the polyurethane 16 may be applied to a plurality of localized areas 16c and 16d on the fiber substrate 12. As shown in FIG. 4C, the thickness of both localized areas 16c and 16d is uniform relative to one another, as well as uniform with respect to each area 16c and 16d.

As shown in FIG. 4D, the polyurethane 16 may be applied to a plurality of localized areas 16e and 16f on the fiber substrate 12 such that the thickness of one or more of the localized areas 16e is greater than one or more of the other localized areas 16f. For example, the thickness of localized area 16e may be 10% to 700% thicker than localized area 16f, and more particularly 50% to 400% thicker than localized area 16f.

As shown in FIG. 4E, the polyurethane 16 may be applied to a plurality of localized areas 16g and 16h on the fiber substrate 12 such that the thickness of one or more of the localized areas 16g varies within the localized area 16g, with a maximum thickness of area 16g being 10% to 700% thicker than the minimum thickness of area 16g, and more particularly 50% to 400% thicker than the minimum thickness of area 16g. As shown the maximum thickness of area 16g may be located within the confines of area 16g and the minimum thickness of area 16g may be located at the perimeter thereof. Alternatively, as shown in FIG. 4F, the maximum thickness of area 16i may be located at a first location of the perimeter of area 16i, and the minimum thickness of area 16i may be located at a second location of the perimeter of area 16i. Again, the maximum thickness of area 16i may be 10% to 700% thicker than the minimum thickness of area 16i, and more particularly 50% to 400% thicker than the minimum thickness of area 16i.

FIG. 4G provides a plan view of the molded fiber substrate of FIG. 1 with the barrier layer 16 applied to plurality of localized areas of the surface of the fiber substrate with the barrier layer is various shapes of circular 16k, oval 16l and rectangular geometry 16m.

While a fiber substrate may be preferred, it is contemplated that the present application of the filled spray urethane composition may be applied to other decoupling layer materials, such as foam, where the foams may include, but not be limited to, urethane foam, polyethylene or EVA (ethylene vinyl acetate) foam.

As noted above, the spray urethane composition may be selectively applied to one or more regions of the decoupler substrate layer. Final part weights may therefore exist in a broad range, depending upon the component in the vehicle for which sound attenuation is desired. In any event, part weights for typical vehicular parts may be in the range of 2.5 kg to 8.5 kg and higher for luxury and diesel vehicular applications. Weight is therefore only limited by the automotive manufacturer's finished part specifications.

It may therefore be appreciated that the present invention is directed to a sound attenuating composite article that may particularly comprise only two layers: a decoupler layer (fiber based) and a sprayed-on polymer layer of polyurethane composition. However, the decoupler may include more than two layers if necessary. The composite article may be tuned to provide desired sound attenuating characteristics in selected vehicle locations such as floor pans, door panels, etc. Reference to “tuned” may be understood that portions of the composite article may be formed to have a specific acoustic impedance designed to attenuate sound in one or more frequencies or frequency bands. Moreover, sound attenuating composite articles herein may have reduced overall weight without sacrificing sound attenuation properties. However, as noted, it is recognized that the two-layer construction herein may be configured to include other sound attenuating layers that may be required for certain application where additional layering may be desired.

For example, one may apply a scrim/web mater comprising woven or non-woven material which may be adhesively and/or mechanically attached to the decoupler. Porous upholstery material may then be attached to the scrim/web material. Various additional operations may then be performed on the composite article herein, to accommodate the requirements of any vehicular noise-attenuation requirements.

While a particular embodiment of the present invention(s) has been described, it should be understood that various changes, adaptations and modifications can be made therein without departing from the spirit of the invention(s) and the scope of the appended claims. The scope of the invention(s) should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

What is claimed is:

1. A sound attenuating composite article comprising:
an acoustic decoupler layer comprising a fiber substrate;
a acoustic barrier layer comprising a filled polymeric material; and
wherein the filled polymeric material is formed in place on and bonded to the fiber substrate at one or more localized areas on the fiber substrate.

2. The article of claim 1 wherein:
the filled polymeric material is formed in place on and bonded to the fiber substrate from reactive components which react to form a thermoset polymer.

3. The article of claim 1 wherein:
the filled polymeric material comprises a polyurethane polymer.

4. The article of claim 1 wherein:
the filled polymeric material is spray formed in place to the fiber substrate.

5. The article of claim 1 wherein:
the filled polymeric material is spray formed in place on the fiber substrate and without use of a forming surface other than a surface of the fiber substrate.

6. The article of claim 1 wherein:
the filled polymeric material includes at least one inorganic mineral filler.

7. The article of claim 6 wherein:
the at least one inorganic mineral filler is present in a range of 50-80% by weight of the filled polymeric material.

8. The article of claim 1 wherein:
the filled polymeric material has an area density in a range of 100-8,000 g/m².

9. The article of claim 1 wherein:
the acoustic barrier layer has at least one localized area which has a thickness which varies; and
the thickness of the localized area varies from a minimum thickness to a maximum thickness of the localized area; and
the maximum thickness of the localized area is in a range between 10-700% greater than the minimum thickness of the localized area.

10. The article of claim 1 wherein:
the acoustic barrier layer has at least first and second localized areas which each have a thickness;
the thickness of the first localized area is greater than the thickness of the second localized area; and
the thickness of the first localized area is in a range between 10-700% greater than the thickness of the second localized area.

11. The article of claim 1 wherein:
the fiber substrate is a fiber batting.

12. The article of claim 1 wherein:
the fiber substrate comprises at least one of natural, synthetic, thermoplastic and thermoset fibers.

13. The article of claim 1 wherein:
the fiber substrate has a thickness in a range of 0.25-75 millimeters.

14. The article of claim 1 wherein:
the fiber substrate has an area density in a range of 30-6,000 g/m².

15. A method of forming a sound attenuating composite article comprising:
providing a fiber substrate, wherein the fiber substrate provides a acoustic decoupler layer;
providing a filled polymeric material, wherein the filled polymeric material provides an acoustic barrier layer; and
forming the filled polymeric material in place on the fiber substrate at one or more localized areas on the fiber substrate and bonding the filled polymeric material to the fiber substrate at the one or more localized areas.

16. The method of claim 15 wherein:
forming the filled polymeric material in place on the fiber substrate at one or more localized areas on the fiber substrate further comprises spraying and reacting the filled polymeric material in place on the fiber substrate such that the filled polymeric material cures on the fiber substrate and bonds the filled polymeric material to the fiber substrate at the one or more localized areas.

17. The method of claim 15 further comprising:
forming the filled polymeric material in place on the fiber substrate in at least one localized area of the fiber substrate with a thickness which varies from a minimum thickness to a maximum thickness of the localized area; and
varying the thickness of the localized area such that the maximum thickness of the localized area is in a range between 10-700% greater than the minimum thickness of the localized area.

18. The method of claim 15 further comprising:
forming the filled polymeric material in place on the fiber substrate in at least first and second localized areas which each have a thickness;
wherein the thickness of the first localized area is greater than the thickness of the second localized area; and
wherein the thickness of the first localized area is in a range between 10-700% greater than the thickness of the second localized area.

19. The method of claim 15 further comprising:
forming the fiber substrate into a shaped article before forming the filled polymeric material in place on the fiber substrate at one or more localized areas on the fiber substrate and bonding the filled polymeric material to the fiber substrate at the one or more localized areas.

20. The method of claim 15 further comprising:
forming the fiber substrate into a shaped article after forming the filled polymeric material in place on the fiber substrate at one or more localized areas on the fiber substrate and bonding the filled polymeric material to the fiber substrate at the one or more localized areas.
